(19) United States
(12) Patent Application Publication
(10) Pub. No.: US 2007/0290038 A1
(43) Pub. Date: Dec. 20, 2007

(54) System and method for accessing data using a wireless device

(76) Inventors: Katrika Woodcock, Brooklyn, NY (US); James Roger Morley-Smith, High Wycombe (GB); Jorg Schlieffers, Streatley-on-Thames (GB)

Correspondence Address: FAY KAPLUN & MARCIN, LLP, 15O BROADWAY, SUITE 702, NEW YORK, NY, 10038, US

(21) Appl. No.: 11/455,538

(22) Filed: Jun. 19, 2006

(51) Int. Cl. G06K 15/00

(52) U.S. Cl. 235/383

(57) ABSTRACT

Described is a system and method for accessing data using a wireless device. The system comprises a wireless device, a database and a computing device. The wireless device obtains product data from a product display. The product data corresponds to a product represented on the product display and includes service data corresponding to a predefined service related to the product. The database stores product-related data. The computing device is communicatively coupled to the wireless device and the database. The wireless device transmits a service request including the service data and the product data to the computing device. The computing device retrieves the product-related data as a function of the product data and the service data and transmits the product-related data to the wireless device.

### FIELD OF THE INVENTION

The present invention generally relates to systems and methods for accessing data using a wireless device.

### BACKGROUND

In a retail environment, a consumer is typically provided with an advertisement which is displayed on a poster or on a display monitor. However, the display does not provide the consumer with detailed information related to an advertised product. If the consumer shows interest in the product, the consumer must seek out a store employee who, even when asked, may not provide the sought after information. In addition, the retailer loses out on an opportunity to further promote the advertised product and/or related products using the display.

### SUMMARY OF THE INVENTION

The present invention generally relates to systems and methods for accessing data using a wireless device. The system comprises a wireless device, a database and a computing device. The wireless device obtains product data from a product display. The product data corresponds to a product represented on the product display and includes service data corresponding to a predefined service related to the product. The database stores product-related data. The computing device is communicatively coupled to the wireless device and the database. The wireless device transmits a service request including the service data and the product data to the computing device. The computing device retrieves the product-related data as a function of the product data and the service data and transmits the product-related data to the wireless device.

### BRIEF DESCRIPTION OF THE DRAWINGS

FIG. 1 shows an exemplary embodiment of a system according to the present invention;

FIG. 2 shows an exemplary embodiment of an advertisement according to the present invention;

FIG. 3 shows an exemplary embodiment of service barcodes according present invention;

FIG. 4 shows an exemplary embodiment of a method according to the present invention;

FIG. 5 shows an exemplary embodiment of an advertising database according to the present invention; and

FIG. 6 shows an exemplary embodiment of a consumer database according to the present invention.

### DETAILED DESCRIPTION

The present invention may be further understood with reference to the following description and the appended drawings, wherein like elements are referred to with the same reference numerals. The present invention generally relates to a system and method for accessing data using a wireless device. In a retail environment, the data may be associated with one or more advertisements or product promotions. However, those of skill in the art will understand that the system and method described herein may be utilized in any location (e.g., a library, a warehouse, a museum, etc.) which utilizes a wireless communications network to access data from remote locations.

FIG. 1 shows an exemplary embodiment of a system 1 according to the present invention. The system 1 may be located in a retail location (e.g., a retail store) and may include a communications network 10 (e.g., a wired/wireless LAN) which is accessible by a portable electronic device (e.g., a mobile unit (“MU”) 15) via an access point/port (“AP”) 20. The MU 15 may be any portable electronic device including, but not limited to, a laser/image-based scanner, an RFID reader, a cell phone, a PDA and a tablet computer. Preferably, the MU 15 includes a barcode scanner and a display (e.g., an LCD). The network 10 may include one or more network computing devices (e.g., a switch, a router, a hub, etc.) which are managed by a server 25. The server 25 may include and/or be coupled to a database 30 which stores advertising data and customer data, as will be described below.

A user of the MU 15 may browse through products while shopping at the retail store. One or more of these products may include a scannable barcode which, when scanned, provides product information about the corresponding product. For example, the MU 15 may scan a product barcode 45 located on a product 40. Barcode data associated with the product 40 is generated and transmitted over the network 10 to the server 25, which queries the database 30 for the product information and returns the product information to the MU 15. In this manner, the user may access information that is not available on the product's packaging. For example, the information may include detailed nutritional information, ingredient information, expiration dates, etc.

When browsing products in the retail store, the user may also encounter one or more advertisement/informational programs, which may be shown on a display 50 (e.g., an LCD, a CRT monitor, a poster, etc.). A plurality of the displays 50 may be located throughout the retail store, including in product aisles, customer service counters, and checkout stations. Display location may depend on factors such as space usage, visibility, customer traffic, ease of access, etc. The programs shown on the display 50 may be displayed in a random fashion, in a repeating loop, or based on an interaction between the user and the display 50. Each display 50 may also have an identifier (e.g., a display ID, an IP address, a hardware address, etc.) associated therewith.

In addition to providing product information, the programs may also include scannable portions, which, when scanned, provide additional information relating to an advertised product or other products related to the advertised product. For example, the MU 15 may scan one or more service barcodes 300, which are shown on the display 50 in conjunction with the advertised product. Barcode data associated with the service barcodes 300 is generated and transmitted over the network 10 to the server 25, which identifies a service request based on the barcode data.

FIG. 2 shows an exemplary embodiment of an advertisement 200 displayed on the display 50 according to the present invention. As shown, the advertisement 200 is a recipe sponsored by one or more advertisers. After viewing the advertisement 200, the user may be interested in learning more about the recipe and/or products related to the recipe (e.g., ingredients used in the recipe). For example, the user may wish to view nutritional information, alternative brand information, and other product information for one or more of the ingredients. The user may also express interest in other services such as printing a copy of the recipe, emailing the recipe to an email account, adding one or more ingredients to a shopping list stored on the MU 15, etc. Using the MU 15, the user initiates the service request by scanning the corresponding service barcode 300. Barcode data is generated and transmitted to the server 25, which fulfills the service request as will be described in detail below.

The service barcode 300 differs from the product barcode 45 in that while both barcodes 45, 300 may be used to access product information, the service barcode 300 may also allow the initiation of the service request. FIG. 3 shows exemplary embodiments of the service barcode 300 according to the present invention. The service barcode 300 may be a coupon barcode 300A, a purchase barcode 300B, a print barcode 300C, etc. When the user wishes to take advantage of a one dollar savings coupon on an advertised ingredient, the user scans the barcode 300A. As a result, the server 25 may associate the coupon with a customer account corresponding to the user. When the user checks out, the server 25 determines whether the user has purchased the advertised ingredient and credits the coupon toward the purchase.

If the user scans the barcode 300B, the server 25 interacts with the MU 15 to enable the user to purchase the ingredients. For example, the server 25 may return an ingredient list for display on the MU 15, allowing the user to toggle through and view the entirety of the list. The user may add and/or remove individual ingredients as well as adding/removing all the ingredients to a shopping list generated by the user. In an exemplary embodiment, the MU 15 may provide an input arrangement (e.g., keypad, phone, walkie-talkie, etc.) allowing the user to provide feedback based on a listing. For example, the user may add comments or notes regarding an ingredient, a particular brand, an item quantity, etc.

If the user scans the barcode 300C, the server 25 transmits a print request to a printer located in the retail store. The server 25 may allow the user to select a printer from a printer list, print to a default printer, or based on selection criteria such as proximity to the user, busyness, etc. For example, the display 50 and/or the MU 15 may include a printer which prints the recipe. The recipe is then printed and made available for pickup. Further service barcodes may be provided for obtaining additional product information (e.g., nutritional information), transmitting the recipe to a home email address/customer account, and checking product availability.

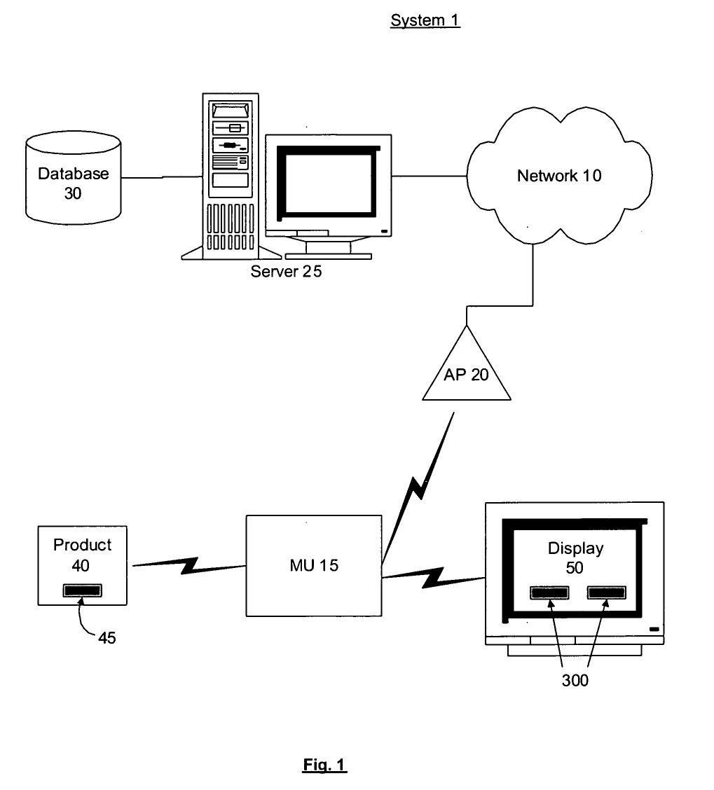

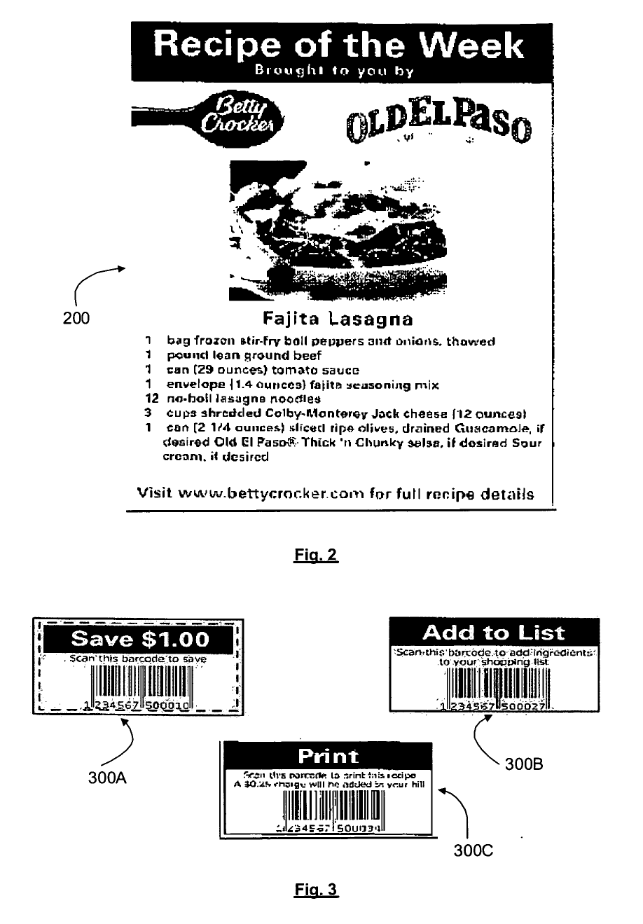

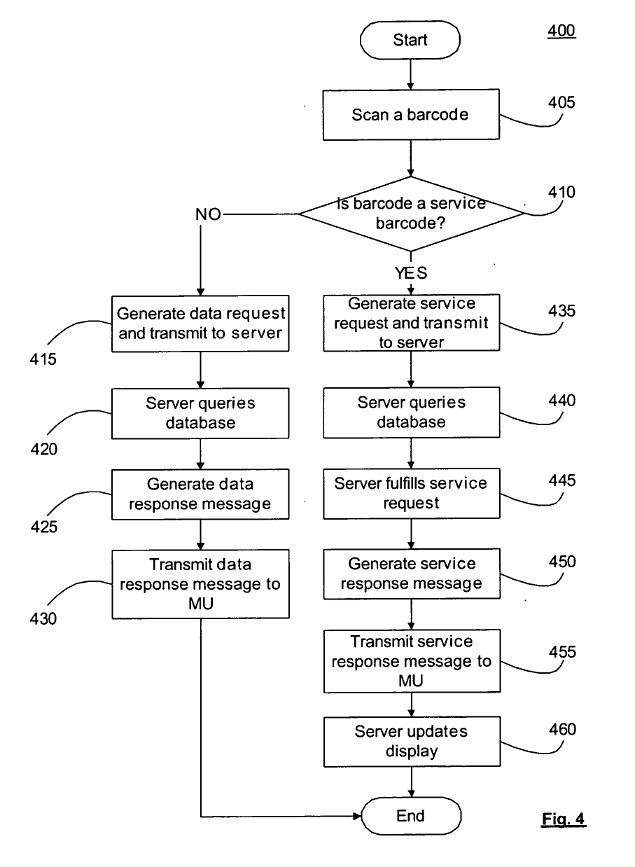

FIG. 4 shows an exemplary embodiment of a method 400 for accessing data using a wireless device according to the present invention. In step 405, the MU 15 scans a barcode. In step 410, it is determined whether the barcode is a product barcode or a service barcode. For example, if the barcode scanned in step 405 is the product barcode 45, the user is requesting product information. Alternatively, if the barcode is a service barcode (e.g., barcodes 300A-C), the user is requesting a service.

In step 415, the barcode is the product barcode 45 and the MU 15 generates and transmits a data request including the product barcode to the server 25. The data request may include information which identifies a product (e.g., the product 40) associated with the barcode. The identification may be unique to the product or shared among a group of similar products.

In step 420, the server 25 receives the data request and queries the database 30 to retrieve the product information. The server 25 searches the database 30 for an entry corresponding to the product identification and reads the product information if the entry is located.

In step 425, the server 25 generates a data response message based on whether the entry was successfully located in step 420. If the entry is not located, the data response message may be an error message informing the user that the product 40 is not in the database 30. In an exemplary embodiment, the server 25 may also alert an administrator or store manager by, for example, recording the error message into an error log for later viewing. If the entry was located, the data response message may include the product information, preferably in an easily readable format. The data response message may include all of the product information or a particular portion thereof (e.g., nutritional information). Accordingly, in other embodiments the user may specify the particular portion and the server 25 generates a data response message which only includes the particular portion.

In step 430, the server 25 transmits the data response message to the MU 15, which displays the data response message to the user. After viewing the data response message, the user may then choose to continue shopping by browsing and/or scanning additional items.

In step 435, the barcode is the service barcode and the MU 15 generates and transmits a service request to the server 25. The service request may include information which identifies an advertisement (e.g., the advertisement 200) and/or a product (e.g., an ingredient) associated with the scanned barcode. The service request may also identify a type of service (e.g., coupon request, purchase request, print request, etc.) requested by the user. The service request may further identify a display (e.g., the display 50) from which the barcode was scanned by, for example, including the display ID of the display.

In step 440, the server 25 has received the service request and queries the database 30 in order to retrieve a database entry corresponding thereto. The query may be substantially similar to that of step 415, and the server 25 may return an error message if no corresponding entry is located.

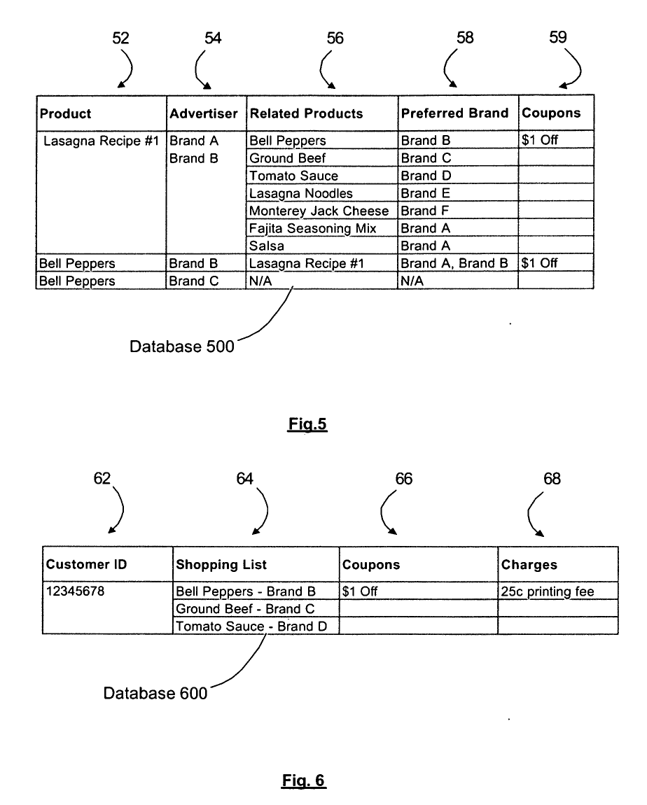

FIG. 5 shows an exemplary embodiment of an advertising database 500 according to the present invention. The advertising database 500 may be a separate database located within the database 30. However, in other embodiments, the advertising database 500 may be integrated with other data (e.g., the product information) stored in the database 30. The advertising database 500 may be a relational database which includes a product field 52, an advertiser field 54, a related products field 56, a preferred brand field 58 and a coupon field 60. The product field 52 may comprise a list of advertised products. For example, the product field 52 may include a product (e.g., lasagna recipe #1) shown in the advertisement 200. The advertiser field 54 lists an advertiser/sponsor (e.g., Brand A and Brand B) associated with the advertised product. The related products field 56 lists products which may be cross-marketed, jointly advertised, or ingredients of the advertised product.

In addition, each product may have a preferred brand field 58 which is promoted over other brands of the same product. For example, the database 500 may include a list of ingredients (e.g., bell peppers, ground beef, tomato sauce, etc.) for the lasagna recipe #1. Each of the ingredients may have a preferred brand which is chosen by the advertiser(s) and/or the retailer. As shown in the exemplary embodiment of the database 500, the lasagna recipe #1 is jointly advertised by Brands A and B along with Brand B bell peppers, whereas Brand C bell peppers are not jointly advertised with any other products.

The coupon field 59 lists discounts and promotions associated with the products. For example, a coupon for one dollar off Brand B bell peppers may be offered. The coupon (e.g., coupon barcode 300A) may be displayed with the advertisement, thus offering an incentive to purchase a particular brand of product (e.g., Brand B bell peppers).

FIG. 6 shows an exemplary embodiment of a customer database 600 according to an exemplary embodiment of the present invention. The customer database 600 may be substantially similar in structure to the advertising database 500 and may be a relational database stored within the database 30. The customer database 600 stores customer records and may include a customer ID field 62, a shopping list field 64, a coupon field 66, a charges field 68, a contact information field (e.g., email, telephone number, etc.), etc.

In step 445, the server 25 fulfills the service request. For example, if the service request is the coupon request, the server 25 may grant a coupon by creating an entry in the coupon field 66 corresponding to a discounted product (e.g., Brand B bell peppers). When the user later engages in a purchase transaction, the server 25 may then determine whether the coupon is valid and applies the coupon to the purchase transaction.

If the service request is the purchase request, the server 25 may update the shopping list field 64 with one or more products. For example, the user may have previously added Brand C Ground Beef and Brand D tomato sauce to the shopping list field 64. After viewing the advertisement 200, the user may have decided to purchase additional products in order to make the lasagna recipe #1. Accordingly, the user would scan the purchase barcode 300B. The server 25 may then fill in any missing ingredients (e.g., bell peppers, lasagna noodles, salsa, etc.) required by the lasagna recipe #1. In other embodiments, the server 25 may also allow the user to select, via the MU 15, which ingredients to add to the shopping list field 64.

If the service request is the print request, the server 25 instructs a printer located in the retail store and/or coupled to the MU 14, either physically or wirelessly, to print the advertisement. The printer may be a default printer (e.g., a printer associated with the user's customer ID). In other embodiments, the printer may be selected by the user from a list of available printers. In yet further embodiments, the server 25 may automatically choose the printer based on busyness, proximity to the user, origin of the service request, etc.

In step 450, the server 25 generates a service response message based on the service request. For example, if the service request is the coupon request, the service response message may be a message stating that the coupon has been successfully applied to the user's customer record. If the service request is the purchase request, the service response message may be a message indicating that the selected products (e.g., the ingredients) were successfully added to the user's shopping list. And, if the service request is the print request, the service response message may include a print confirmation which tells the user where the print job may be retrieved.

In step 455, the server 25 transmits the service response message to the MU 15. In optional step 460, the server updates the display 50 in order to provide a new program to the user. The display 50 may be updated by transmitting the new program to a display corresponding to the display ID included with the service request. In an exemplary embodiment, the selection of the new program is based on the previous program and/or the barcode scanned in step 405. For example, if the previous program is the advertisement 200, the display 50 may be updated with a similar advertisement (e.g., another recipe). Similarly, if the barcode scanned is the coupon barcode 300A, the display 50 may be updated with a related product (e.g., another ingredient). Thus, the display 50 may be used to provide additional programs which may be of interest to the user.

The present invention may also be utilized to gather marketing data and provide targeted advertising at the displays based on barcode usage. Those skilled in the art will understand that some of the service requests described above (e.g., the purchase request) may require the user to identify himself. For example, prior to scanning the barcode in step 405, the user may enter a unique identifier such as a credit card number, the customer ID, an email address, a customer barcode, etc. The user may also enter data into a customer profile, such as demographic data (e.g., name, address, income, children, marital status, etc.). Thus, information regarding the user's particular interests (e.g. marketing data) may be used to market additional products to the user. For example, as described above, the user may be presented with the similar advertisement based on an expressing of interest (e.g., scanning the barcode). Thus, the display 50 may be utilized to push for a particular branded product or entice the user with further offers/promotions.

The marketing data may also be collected without identifying the user. For example, the marketing data may be collected based on anonymous users scanning barcodes throughout the retail store. If a predetermined number of the anonymous users express interest in a particular product, the interest may be recorded as part of the marketing data.

Those skilled in the art will understand that by allowing the user to initiate the data and service requests, the present invention presents several significant advantages. In addition to providing for interaction between the user and retailer throughout the shopping experience, the present invention also provides significant cost-savings compared to printed media (e.g., circulars, clippable coupons, etc.).

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A system, comprising:
a wireless device obtaining product data from a product display, the product data corresponding to a product represented on the product display and including service data corresponding to a predefined service related to the product;
a database storing product-related data; and
a computing device communicatively coupled to the wireless device and the database,
wherein the wireless device transmits a service request including the service data and the product data to the computing device, and
wherein the computing device retrieves the product-related data as a function of the product data and the service data and transmits the product-related data to the wireless device.

2. The system according to claim 1, wherein the wireless device includes at least one of a laser-based scanner, an imager-based scanner, an RFID reader, a mobile phone, a PDA and a handheld computer.

3. The system according to claim 1, wherein the product display is one of a display screen and a poster.

4. The system according to claim 1, wherein the product data is one of a bar code and an RFID tag.

5. The system according to claim 1, wherein the service data is a service identifier corresponding to one of the following predefined services: (i) obtaining nutritional information about the product, (ii) obtaining ingredient information about at least one ingredient of the product, (iii) printing a coupon for the product, (iv) adding the product to an electronic shopping list and (v) obtaining a recipe for the product.

6. The system according to claim 5, wherein the product-related data is at least one of a price, the nutritional information, the ingredient information, the coupon and the recipe.

7. The system according to claim 5, wherein the computing device maintains the electronic shopping list that corresponds to the wireless device.

8. The system according to claim 5, wherein, upon receipt of the product-related data, the wireless device one of (i) displays the product-related data on a display screen thereof and (ii) prints the product-related data on a printer coupled thereto.

9. A method, comprising:
obtaining product data from a product display, the product data corresponding to a product represented on the product display and including service data corresponding to a predefined service related to the product;
transmitting a service request including the product data and the service data to a computing device; and
upon receipt of a service response, displaying product-related data, wherein the service response is generated by the computing device in response to the service request and includes the product-related data corresponding to the product data and the service data.

10. The method according to claim 9, wherein the product display is one of a display screen and a poster.

11. The method according to claim 9, wherein the obtaining step includes one of the following substeps:
scanning a bar code on the product display; and
reading an RFID tag on the product display.

12. The method according to claim 9, wherein the service data is a service identifier corresponding to one of the following predefined services: (i) obtaining nutritional information about the product, (ii) obtaining ingredient information about at least one ingredient of the product, (iii) printing a coupon for the product, (iv) adding the product to an electronic shopping list and (v) obtaining a recipe for the product.

13. The method according to claim 12, wherein the product-related data is at least one of a price, the nutritional information, the ingredient information, the coupon and the recipe.

14. The method according to claim 9, further comprising:
adding the product to an electronic shopping list.

15. The method according to claim 9, further comprising:
printing the product-related data on a printer.

16. A device, comprising:
a data capture arrangement obtaining product data from a product display, the product data corresponding to a product represented on the product display and including service data corresponding to a predefined service related to the product;
a wireless communications arrangement transmitting a service request including the product data and the service data to a computing device, the wireless communications arrangement receiving a service response including product-related data; and
a display screen displaying the product-related data,
wherein the service response is generated by the computing device in response to the service request and includes the product-related data corresponding to the product data and the service data.

17. The device according to claim 16, wherein the data capture arrangement includes at least one of a laser-based scanner, an imager-based scanner and an RFID reader.

18. The device according to claim 16, wherein the service data is a service identifier corresponding to one of the following predefined services: (i) obtaining nutritional information about the product, (ii) obtaining ingredient information about at least one ingredient of the product, (iii) printing a coupon for the product, (iv) adding the product to an electronic shopping list and (v) obtaining a recipe for the product.

19. The device according to claim 16, wherein the product-related data is at least one of a price, the nutritional information, the ingredient information and the coupon.

20. The device according to claim 16, further comprising:
a printer, wherein, when the product-related data includes a coupon for the product, the printer prints the coupon.

21. A device, comprising:
a data capture means for obtaining product data from a product display, the product data corresponding to a product represented on the product display and including service data corresponding to a predefined service related to the product;
a wireless communications means for transmitting a service request including the product data and the service data to a computing means, the wireless communications means receiving a service response including product-related data; and
a display means for displaying the product-related data,
wherein the service response is generated by the computing means in response to the service request and includes the product-related data corresponding to the product data and the service data.
